(19) United States
(12) Patent Application Publication
(10) Pub. No.: US 2011/0072117 A1
(43) Pub. Date: Mar. 24, 2011

(54) Generating a Synthetic Table of Contents for a Volume by Using Statistical Analysis

(75) Inventors: Jens Nicholas Wessling, Ann Arbor, MI (US); Dustin James Williams, Dexter, MI (US)

(73) Assignee: Rovi Technologies Corporation

(21) Appl. No.: 12/565,626

(22) Filed: Sep. 23, 2009

(51) Int. Cl. G06F 15/177

(52) U.S. Cl. 709/221

(57) ABSTRACT

A method and a system are provided for generating a synthetic table of contents for a volume. The synthetic table of contents may be used to identify a volume efficiently despite natural variations found in different occurrences of a volume. In one example, the system receives unprocessed durations for each chapter of the volume. The volume includes chapters. The system identifies acceptable durations for each chapter by applying a first statistical analysis to the unprocessed durations for each chapter. The system calculates a representative duration for each chapter by applying a second statistical analysis to the acceptable durations for each chapter. The calculating generates representative durations for the chapters. The system then generates a synthetic table of contents for the volume by organizing the representative durations for the chapters of the volume.

### FIELD OF THE INVENTION

The invention relates to tables of contents for volumes. More particularly, the invention relates to using a synthetic table of contents to identify a volume.

### BACKGROUND

A conventional optical disc is typically recognized by reading table of contents data from the disc. The table of contents data may then be used to lookup, in a database, information about the contents of the optical disc. Examples of optical discs include a compact disc (CD), a digital video disc (DVD) and a Blu-ray Disc.

U.S. Pat. Nos. 6,230,192 and 6,330,593 (the '192 and '593 patents), which are hereby incorporated by reference, provide conventional examples of methods of identifying a disc and looking up disc information. The '192 and the '593 patents relate generally to delivering supplemental entertainment content to a user listening to a musical chapter. Using conventional techniques, an album identifier is computed for the album being played. The album identifier may be determined based on the number and lengths of tracks on the album. The album identifier is used to retrieve, from a database, information relating to the chapters played by the user.

### SUMMARY

A table of contents of a volume (e.g., album) can be represented by the numerical durations of the individual chapters (e.g., tracks) of the volume. A table of contents may be referred to as an identifier for the volume. Examples of a volume include an album, a book, magazine, publication, a movie, a CD, a DVD, and/or a Blu-ray Disc, among other things. Examples of a chapter include an audio track, a video track, a song, a book chapter, magazine chapter, publication chapter, a CD chapter, a DVD chapter and/or a Blu-ray Disc chapter, among other things.

A single volume may have multiple different tables of contents due to different pressings and/or different releases of the volume. In order to identify a volume by comparing tables of contents, one must compare the table of contents generated from a specific disc to all other known tables of contents. Unfortunately, such comparing is typically a time consuming process. Conventional systems do not account for some of the obstacles related to identifying chapters. The advent of digital media (e.g., audio, video and metadata) has caused the sheer size of data to become enormous. When a user device queries a server, the server may have to search through an enormous amount of data to provide a result for the query. Conventional methods of retrieving data are decreasing in efficiency because methods of searching data sets are not evolving as quickly as the data sets are getting bigger.

To reduce identification time and to increase identification accuracy, a system is provided for generating a single synthetic table of contents that effectively represents all known tables of contents for a volume. Identification of a given volume may then be simplified to receiving the table of contents for that volume, and then comparing that table of contents to the synthetic table of contents in a database.

In a first embodiment, a method is provided for generating a synthetic table of contents for a volume. The method is configured to be carried out by at least one computer. The method comprises the following: receiving one or more unprocessed durations for each chapter of the volume, wherein the volume includes one or more chapters; identifying one or more acceptable durations for each chapter by applying a first statistical analysis to the one or more unprocessed durations for each chapter; and calculating a representative duration for each chapter by applying a second statistical analysis to the one or more acceptable durations for each chapter, wherein the calculating generates one or more representative durations for the one or more chapters.

In a second embodiment, a system is provided for generating a synthetic table of contents for a volume. The system is configured for the following: receiving one or more unprocessed durations for each chapter of the volume, wherein the volume includes one or more chapters; identifying one or more acceptable durations for each chapter by applying a first statistical analysis to the one or more unprocessed durations for each chapter; and calculating a representative duration for each chapter by applying a second statistical analysis to the one or more acceptable durations for each chapter, wherein the calculating generates one or more representative durations for the one or more chapters.

In a third embodiment, a computer readable medium comprises one or more instructions for generating a synthetic table of contents for a volume. The one or more instructions are configured to cause one or more processors to perform the following steps: receiving one or more unprocessed durations for each chapter of the volume, wherein the volume includes one or more chapters; identifying one or more acceptable durations for each chapter by applying a first statistical analysis to the one or more unprocessed durations for each chapter; and calculating a representative duration for each chapter by applying a second statistical analysis to the one or more acceptable durations for each chapter, wherein the calculating generates one or more representative durations for the one or more chapters.

Preferably, the system generates a synthetic table of contents for the volume by organizing the one or more representative durations for the one or more chapters of the volume. The synthetic table of contents is preferably an effective representation of one or more tables of contents of the volume. The synthetic table of contents is preferably substantially less data than the one or more tables of contents of the volume. The synthetic table of contents allows data associated with the volume to be searched, organized, located and/or analyzed in an efficient manner.

Each unprocessed duration is preferably a duration of an occurrence of a chapter. An occurrence is a copy of the chapter. The one or more unprocessed durations are received from one or more user devices configured for storing occurrences. Each user device is preferably a client part of a client-server architecture.

The invention encompasses other embodiments configured as set forth above and with other features and alternatives. It should be appreciated that the invention can be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a block diagram of a system for generating a synthetic table of contents for a volume, in accordance with some embodiments;

FIG. 2 is a schematic diagram of a system for generating a synthetic table of contents, in accordance with some embodiments;

FIG. 3A is a schematic diagram of a system for receiving unprocessed durations for occurrences of a single chapter of a volume, in accordance with some embodiments;

FIG. 3B is a schematic diagram of a system for calculating a representative duration for a single chapter of a volume, in accordance with some embodiments;

FIG. 4 is flowchart of a method for generating a synthetic table of contents of a volume, in accordance with some embodiments;

FIG. 5 is a block diagram of a system for searching for volumes by using synthetic tables of contents, in accordance with some embodiments; and

FIG. 6 is a block diagram of a general/special purpose computer system, in accordance with some embodiments.

### DETAILED DESCRIPTION

An invention is disclosed for a method and a system for generating a synthetic table of contents for a volume. Numerous specific details are set forth in order to provide a thorough understanding of the invention. It will be understood, however, to one skilled in the art, that the invention may be practiced with other specific details.

### DEFINITIONS

Some terms are defined below in alphabetical order for easy reference. These terms are not rigidly restricted to these definitions. A term may be further defined by its use in other sections of this description.

“Album” means a collection of tracks. An album is typically originally published by an established entity, such as a recording label (e.g., recording company, such as Warner or Universal).

“Audio Fingerprint” (e.g., “fingerprint”, “acoustic fingerprint”, or “digital fingerprint”) is a digital measure of certain acoustic properties that is deterministically generated from an audio signal that can be used to identify an audio sample and/or quickly locate similar items in an audio database. An audio fingerprint typically operates as a unique identifier for a particular item, such as, for example, a CD, a DVD and/or a Blu-ray Disc. An audio fingerprint is an independent piece of data that is not affected by metadata. The company Rovi™ has databases that store over 25 million unique fingerprints for various audio samples. Practical uses of audio fingerprints include without limitation identifying songs, identifying records, identifying melodies, identifying tunes, identifying advertisements, monitoring radio broadcasts, monitoring peer-to-peer networks, managing sound effects libraries and/or identifying video files.

“Audio Fingerprinting” is the process of generating an audio fingerprint. U.S. Pat. No. 7,277,766 (the '766 patent), entitled “Method and System for Analyzing Digital Audio Files”, which is herein incorporated by reference, provides an example of an apparatus for audio fingerprinting an audio waveform. U.S. Pat. No. 7,451,078 (the '078 patent application), entitled “Methods and Apparatus for Identifying Media Objects”, which is herein incorporated by reference, provides an example of an apparatus for generating an audio fingerprint of an audio chapter. U.S. patent application Ser. No. 12/456,177, by Jens Nicholas Wessling, entitled “Managing Metadata for Occurrences of a Recording”, which is herein incorporated by reference, provides an example of identifying metadata by storing an internal identifier (e.g., fingerprint) in the metadata.

“Blu-ray”, also known as Blu-ray Disc, means a disc format jointly developed by the Blu-ray Disc Association, and personal computer and media manufacturers (including Apple, Dell, Hitachi, HP, JVC, LG, Mitsubishi, Panasonic, Pioneer, Philips, Samsung, Sharp, Sony, TDK and Thomson). The format was developed to enable chapter, rewriting and playback of high-definition video (HD), as well as storing large amounts of data. The format offers more than five times the storage capacity of conventional DVDs and can hold 25 GB on a single-layer disc and 800 GB on a 20-layer disc. More layers and more storage capacity may be feasible as well. This extra capacity combined with the use of advanced audio and/or video codecs offers consumers an unprecedented HD experience. While current disc technologies, such as CD and DVD, rely on a red laser to read and write data, the Blu-ray format uses a blue-violet laser instead, hence the name Blu-ray. The benefit of using a blue-violet laser (605 nm) is that it has a shorter wavelength than a red laser (650 nm). A shorter wavelength makes it possible to focus the laser spot with greater precision. This added precision allows data to be packed more tightly and stored in less space. Thus, it is possible to fit substantially more data on a Blu-ray Disc even though a Blu-ray Disc may have the substantially similar physical dimensions as a traditional CD or DVD.

“Chapter” means audio/visual data block for playback. A chapter is preferably a computer readable digital chapter. Examples of a chapter include without limitation an audio track, a video track, a song, a book chapter, magazine chapter, a publication chapter, a CD chapter, a DVD chapter and/or a Blu-ray Disc chapter.

“Compact Disc” (CD) means a disc used to store digital data. A CD was originally developed for storing digital audio. Standard CDs have a diameter of 740 mm and can typically hold up to 80 minutes of audio. There is also the mini-CD, with diameters ranging from 60 to 80 mm. Mini-CDs are sometimes used for CD singles and typically store up to 24 minutes of audio. CD technology has been adapted and expanded to include without limitation data storage CD-ROM, write-once audio and data storage CD-R, rewritable media CD-RW, Super Audio CD (SACD), Video Compact Discs (VCD), Super Video Compact Discs (SVCD), Photo CD, Picture CD, Compact Disc Interactive (CD-i), and Enhanced CD. The wavelength used by standard CD lasers is 650 nm, and thus the light of a standard CD laser typically has a red color.

“Database” means a collection of data organized in such a way that a computer program may quickly select desired pieces of the data. A database is an electronic filing system. In some implementations, the term “database” may be used as shorthand for “database management system”.

“Device” means software, hardware or a combination thereof. A device may sometimes be referred to as an apparatus. Examples of a device include without limitation a software application such as Microsoft Word™, a laptop computer, a database, a server, a display, a computer mouse, and a hard disk.

“Digital Video Disc” (DVD) means a disc used to store digital data. A DVD was originally developed for storing digital video and digital audio data. Most DVDs have the substantially similar physical dimensions as compact discs (CDs), but DVDs store more than six times as much data. There is also the mini-DVD, with diameters ranging from 60 to 80 mm. DVD technology has been adapted and expanded to include DVD-ROM, DVD-R, DVD+R, DVD-RW, DVD+RW and DVD-RAM. The wavelength used by standard DVD lasers is 650 nm, and thus the light of a standard DVD laser typically has a red color.

“Network” means a connection between any two or more computers, which permits the transmission of data. A network may be any combination of networks, including without limitation the Internet, a local area network, a wide area network, a wireless network and a cellular network.

“Occurrence” means a copy (e.g., instance) of a chapter. Different occurrences of a same pressing are typically exact copies. However, an occurrence is not necessarily an exact copy of a chapter, and may be a substantially similar copy. A chapter may be an inexact copy for a number of reasons, including without limitation an imperfection in the copying process, different pressings having different settings, different copies having different encodings, different releases of the chapter and other reasons. Accordingly, a chapter may be the source for multiple occurrences that may be exact copies or substantially similar copies. Different occurrences may be located on different devices, including without limitation different user devices, different mp3 players, different databases, different laptops, and so on. Each occurrence of a chapter may be located on any appropriate storage medium, including without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of storage device. Occurrences may be compiled, such as in a database or in a listing.

“Pressing” (e.g., “disc pressing”) means producing a disc in a disc press from a master. A disc press preferably produces a disc for a reader that utilizes a laser beam having a bandwidth of about 780 nm for CD, about 650 nm for DVD, about 605 nm for Blu-ray Disc or another bandwidth as may be appropriate.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Signature” means an identifying means that uniquely identifies an item, such as, for example, a volume, a track, a song, an album, a CD, a DVD and/or Blu-ray Disc, among other items. Examples of a signature include without limitation the following in a computer-readable format: an audio fingerprint, a portion of an audio fingerprint, a signature derived from an audio fingerprint, an audio signature, a video signature, a disc signature, a CD signature, a DVD signature, a Blu-ray Disc signature, a media signature, a high definition media signature, a human fingerprint, a human footprint, an animal fingerprint, an animal footprint, a handwritten signature, an eye print, a biometric signature, a retinal signature, a retinal scan, a DNA signature, a DNA profile, a genetic signature and/or a genetic profile, among other signatures. A signature may be any computer-readable string of characters that comports with any coding standard in any language. Examples of a coding standard include without limitation alphabet, alphanumeric, decimal, hexadecimal, binary, American Standard Code for Information Interchange (ASCII), Unicode and/or Universal Character Set (UCS). Certain signatures may not initially be computer-readable. For example, latent human fingerprints may be printed on a door knob in the physical world. A signature that is initially not computer-readable may be converted into a computer-readable signature by using any appropriate conversion technique. For example, a conversion technique for converting a latent human fingerprint into a computer-readable signature may include a ridge characteristics analysis.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“Song” means a musical composition. A song is typically recorded onto a track by a recording label (e.g., recording company). A song may have many different versions, for example, a radio version and an extended version.

“System” means a device or multiple coupled devices. A device is defined above.

“Table of Contents” means the set of lengths of chapters of a volume. U.S. Pat. No. 7,359,900 (the '900 patent), entitled “Digital Audio Track Set recognition System”, which is hereby incorporated by reference, provides an example of a method of using table of contents data to identify a disc. The '900 patent also describes a method of using the identification of a disc to lookup metadata in a database and then sending that metadata to an end user.

“Track” means an audio/visual chapter. A track may be on a disc, such as, for example, a Blu-ray Disc, a CD or a DVD.

“User” means a consumer, client, and/or client device in a marketplace of products and/or services.

“User device” (e.g., “client”, “client device” or “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a CD player, a DVD player, a Blu-ray Disc player, a personal media device, a portable media player, an iPod™, a Zune™ Player, a laptop computer, a palmtop computer, a smart phone, a cell phone, a mobile phone, an mp3 player, a digital audio recorder, a digital video recorder, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Volume” means a group of chapters of audio/visual data for playback. A volume may be referred to as an album, a movie, a CD, a DVD, and/or a Blu-ray Disc, among other things.

“Web browser” means any software program which can display text, graphics, or both, from Web pages on Web sites. Examples of a Web browser include without limitation Mozilla Firefox™ and Microsoft Internet Explorer™.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo™ Web server.

“Web site” means at least one Web page, and more commonly a plurality of Web pages, virtually coupled to form a coherent group.

### I.

### Overview of Architecture

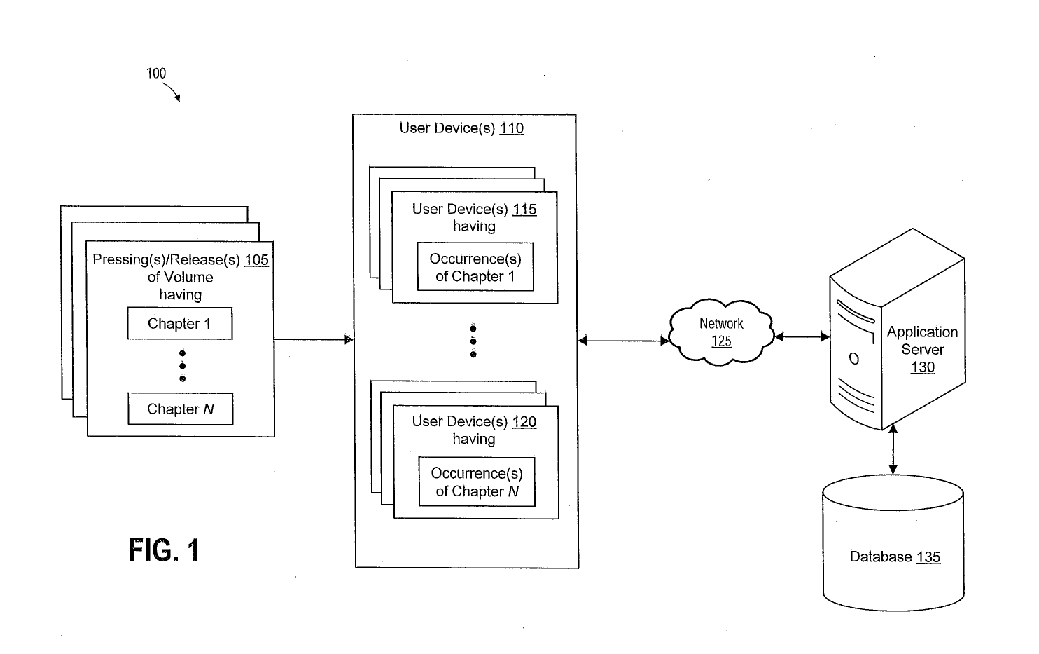

FIG. 1 is a block diagram of a system 100 for generating a synthetic table of contents for a volume, in accordance with some embodiments. A network 125 is coupled to an application server 130 and user devices 110. A user device may be, for example, a laptop computer, a standalone disc player, an mp3 player or a smart phone, among other things. A user device may store, among other things, an occurrence of a chapter from the volume.

The application server 130 is preferably coupled to (or includes) a database 135. The database 135 may store, among other things, data collected and/or generated from an item stored in one or more user devices 110. The database 135 preferably includes tables of contents of volumes. The database 135 may also include data associated items, such as, for example albums, CDs, DVDs and/or Blu-ray Discs, among other things.

The user devices 110 preferably receive occurrences of chapters from one or more pressings/releases 105 of a volume. The volume includes one or more chapters, including Chapter 1 through Chapter N, where N is a positive integer. The user devices 115 each store at least one occurrence of Chapter 1. As further shown, the user devices 120 each store at least one occurrence of Chapter N. Accordingly, the user devices 110 store, collectively among them, occurrences of Chapter 1 through Chapter N.

An occurrence is a copy of a chapter. An occurrence may be, for example, a track that is uploaded from a CD that is inputted into the user device. An occurrence is preferably an exact copy of the chapter. For example, different occurrences of a same pressing are typically exact copies. However, an occurrence is not necessarily an exact copy of a chapter, and may be a substantially similar copy. A chapter may be an inexact copy for a number of reasons, including without limitation an imperfection in the copying process, different pressings having different settings, different copies having different encodings, different releases of the chapter and other reasons. The chapter may be released in a multitude of different ways and in different contexts. For example, a given chapter may exist on an original CD, a greatest hits CD, a mix CD, a movie soundtrack, a DVD and/or a digital file, among other things.

Each user device preferably includes hardware and/or software configured for communicating with the application server 130. For example, a user device may have an operating system with a graphical user interface (GUI) to access the Internet and is preferably equipped with World Wide Web (Web) browser software, such as Mozilla Firefox™, operable to read and send Hypertext Markup Language (HTML) forms from and to a Hypertext Transport Protocol (HTTP) server on the Web. A standalone disc player may have a built-in interface that enables the player to communicate with the application server 130 via the network 125, either directly or through another computer. For example, a disc player may have a data interface (e.g., an IDE interface or a USB interface) that enables the disc player to send and receive data from a laptop computer, which in turn is coupled to the network 125.

Likewise, the application server 130 preferably includes software and/or hardware for communicating with the user devices 110. For example, the application server 130 may have HTTP compliant software, an operating system and common gateway interface (CGI) software for interfacing with a user device via the network 125. Alternatively, the application server 130 and a user device may run proprietary software that enables them to communicate via the network 125.

It will be readily appreciated that the schematic of FIG. 1 is for explanatory purposes, and that numerous variations are possible. For example, the application server 130 may be coupled to a local area network (LAN), which in turn may be coupled to the network 125. In another example, the application server 130 may be coupled to multiple Web servers. In yet another example, the system 100 may include a database (or system of databases) arranged in a configuration that is different than the database 135 depicted here. Other configurations exist as well.

### II.

### Generating a Synthetic Table of Contents by Using Statistical Analysis

The system may generate a synthetic table of contents from durations of occurrences of chapters of a volume. An occurrence is a copy of a chapter. A chapter preferably includes media data for playback. Examples of a chapter include without limitation an audio track, a video track, a song, a book chapter, magazine chapter, publication chapter, a CD chapter, a DVD chapter and/or a Blu-ray Disc chapter.

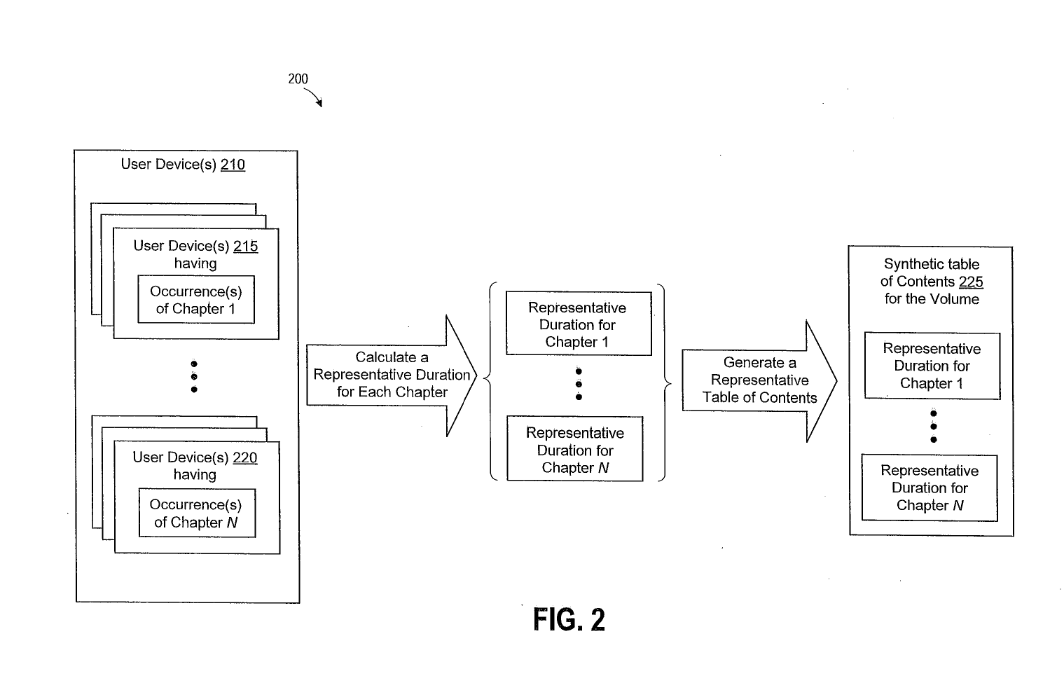

FIG. 2 is a schematic diagram of a system 200 for generating a synthetic table of contents, in accordance with some embodiments. The user devices 210 collectively store, among them, occurrences of Chapter 1 through Chapter N. More particularly, user devices 215 each store at least one occurrence of Chapter 1. Storage of the occurrences continues through user devices 220, which each have at least one occurrence of Chapter N, where N is a positive integer.

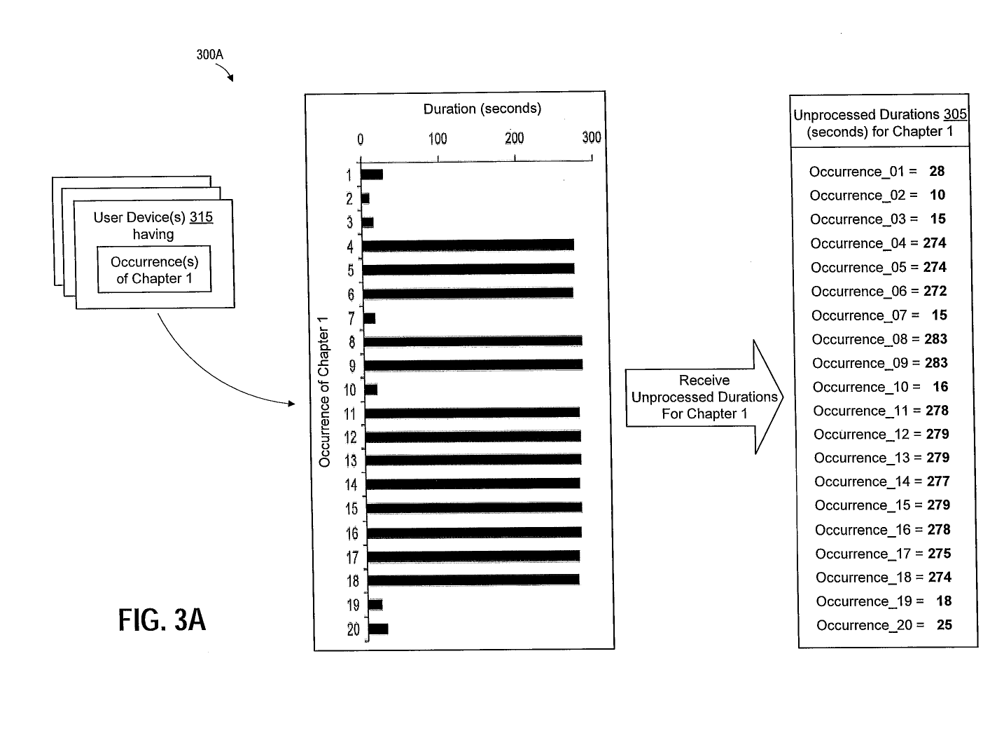

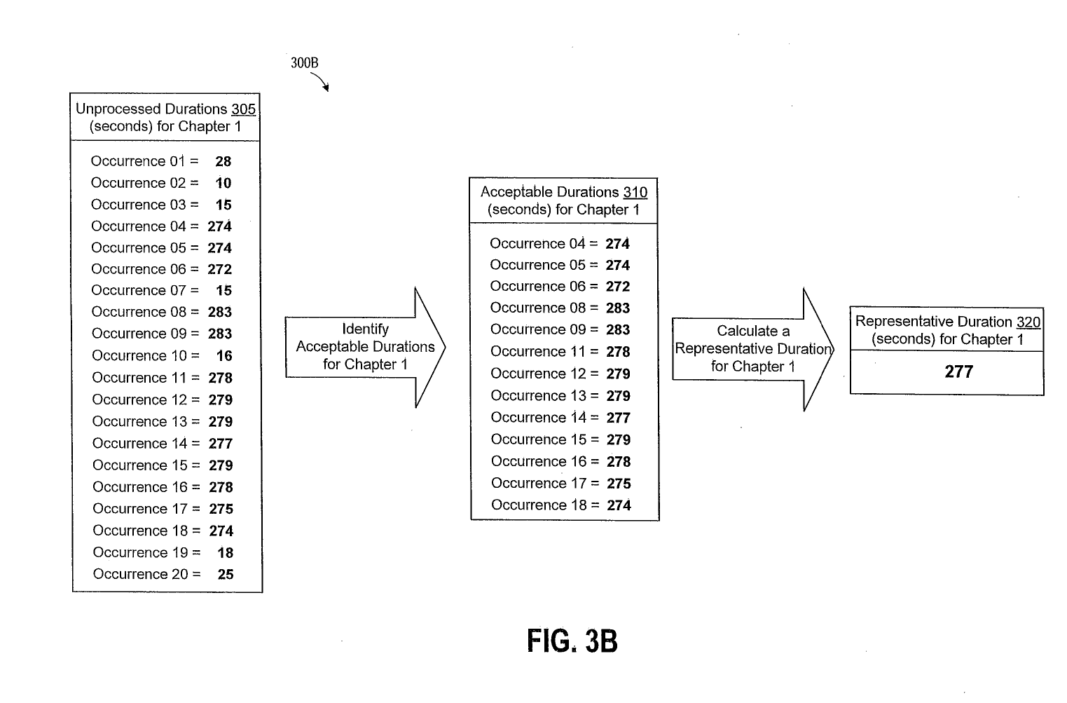

Each occurrence of a chapter has an amount of time required playback also known as running time or duration. The system 200 calculates a representative duration for each chapter. The system 200 calculates a representative duration for each chapter by performing a sequence of statistical analyses on the durations of the occurrences. These statistical analyses are discussed further below with respect to FIG. 3A and FIG. 3B. From the representative durations, the system 200 then generates a synthetic table of contents 225 for the volume. More details of these processes are discussed below with respect to FIG. 3A and FIG. 3B.

FIG. 3A is a schematic diagram of a system 300A for receiving unprocessed durations for occurrences of a single chapter of a volume, in accordance with some embodiments. Note that the description here focuses on Chapter 1 for explanatory purposes. However, this explanation of FIG. 3A applies to one or more chapters of the volume.

The system 300A receives from user devices all or several of the durations of the occurrences for a given chapter. For example, the system 300A illustrated in FIG. 3A receives from user devices 315 all of the durations of the occurrences for Chapter 1. These user devices 315 store various tables of contents for the given volume.

The bar chart of FIG. 3A illustrates durations of occurrences of Chapter 1. For explanatory purposes, the bar chart shows 20 occurrences of Chapter 1. However, Chapter 1 and/or any other chapter may have any number of occurrences. The system 300A receives the durations of these 20 occurrences from the user devices 315. These durations of the 20 occurrences are referred to as unprocessed durations 305 for Chapter 1. FIG. 3A shows in time units of seconds the unprocessed durations 305. For instance, the duration for Occurrence_01 is 28 seconds. The duration for Occurrence_02 is 10 seconds. The duration for Occurrence_03 is 15 seconds. The duration for Occurrence_04 is 274 seconds. The duration for Occurrence_05 is 274 seconds. The duration for Occurrence_06 is 272 seconds. The duration for Occurrence_07 is 15 seconds. The duration for Occurrence_08 is 283 seconds. The duration for Occurrence_09 is 283 seconds. The duration for Occurrence_10 is 16 seconds. The duration for Occurrence_11 is 278 seconds. The duration for Occurrence_12 is 279 seconds. The duration for Occurrence_13 is 279 seconds. The duration for Occurrence_14 is 277 seconds. The duration for Occurrence_15 is 279 seconds. The duration for Occurrence_16 is 278 seconds. The duration for Occurrence_17 is 275 seconds. The duration for Occurrence_18 is 274 seconds. The duration for Occurrence_19 is 18 seconds. The duration for Occurrence_20 is 25 seconds.

It is readily apparent that the durations of the occurrences are not the same. Some of the durations are relatively short at about 25 seconds or less. Most of the durations are relatively long at about 280 seconds. These durations for the occurrences of Chapter 1 have multiple different durations for perhaps a number of reasons. A first reason is that certain occurrences may originate from different pressings and/or different releases of the volume. A second reason is that certain pressings may have imperfections that cause durations to be slightly different than durations from other pressings. A third reason is that a recording label may release slightly different versions of the album containing the volume. A fourth reason is that users may alter occurrences of the chapter. Other reasons for the differences in the durations exist as well. The system uses the unprocessed durations for subsequent processing, as discussed below with reference to FIG. 3B.

FIG. 3B is a schematic diagram of a system 300B for calculating a representative duration for a single chapter of a volume, in accordance with some embodiments. The description here continues to focus on Chapter 1 for explanatory purposes. However, this explanation of FIG. 3B applies not only to a single chapter, but to all the chapters of the volume. The system 300B considers unprocessed durations 305 for Chapter 1. FIG. 3B shows the unprocessed durations 305 in time units of seconds.

The system identifies acceptable durations for the given chapter. For example, the system 300B may identify acceptable durations for Chapter 1 by applying a first statistical analysis to the unprocessed durations 305. This first statistical analysis may include one or more statistical analyses. For explanatory purposes, FIG. 3B shows the results of one of many possible statistical analyses. For example, the system 300B calculates a standard deviation of the unprocessed durations 305. A standard deviation is one of many possible statistical analyses that may be performed here. One standard deviation for this set of unprocessed durations 305 is about 127 seconds.

The system 300B considers all unprocessed durations 305 that are less than one (1) standard deviation away from the maximum duration. The maximum duration is 283 seconds, which is the duration for both Occurrence_08 and Occurrence_09. Accordingly, any duration that is greater than 156 seconds (283 seconds minus 127 seconds) is acceptable. The acceptable durations 310 for Chapter 1 include the durations for the following occurrences: Occurrence_04 (274 seconds), Occurrence_05 (274 seconds), Occurrence_06 (272 seconds), Occurrence_08 (283 seconds), Occurrence_09 (283 seconds), Occurrence_11 (278 seconds), Occurrence_12 (279 seconds), Occurrence_13 (279 seconds), Occurrence_14 (277 seconds), Occurrence_15 (279 seconds), Occurrence_16 (278 seconds), Occurrence_17 (275 seconds), Occurrence_18 (274 seconds).

The system 300B discards all unprocessed durations 305 that are greater than one (1) standard deviation away from the maximum duration. The maximum duration in this case is about 283 seconds, which is the duration for both Occurrence_08 and Occurrence_09. Accordingly, any duration that is less than 156 seconds (283 seconds minus 127 seconds) is discarded. The discarded durations include the durations for the following occurrences: Occurrence_01 (28 seconds), Occurrence_02 (10 seconds), Occurrence_03 (15 seconds), Occurrence_07 (15 seconds), Occurrence_10 (16 seconds), Occurrence_19 (18 seconds) and Occurrence_20 (25 seconds).

The system calculates a representative duration for the given chapter. For example, the system 300B calculates a representative duration for Chapter 1 by applying a second statistical analysis to the acceptable durations 310. This second statistical analysis may include one or more statistical analyses. For explanatory purposes, FIG. 3B shows the results of one of many possible statistical analyses. The system 300B averages the acceptable durations 310 for Chapter 1. The average of the acceptable durations 310 is the representative duration 320 for Chapter 1. This representative duration 320 is preferably a highly representative duration for the acceptable durations 310. Likewise, this representative duration 320 is preferably a highly representative duration for Chapter 1 of the volume.

The system calculates a representative duration for each of the other chapters of the volume. Referring again to FIG. 2, once all of the chapters have a representative duration, the system may then generate a single synthetic table of contents for the volume. The synthetic table of contents preferably represents all known tables of contents for the given volume. The synthetic table of contents thereby provides, in a single table, a representation of many tables of contents. The synthetic table of contents is preferably substantially less data than the sum of all the tables of contents.

Because the system determines the synthetic table of contents by using a statistical analysis, the synthetic table of contents may not be equal to any actual table of contents from a physical disc. For example, it is quite possible that no physical disc is represented by the synthetic table of contents that the system generates here. The synthetic table of contents is intended to represent tables of contents that are derived directly from physical discs. The synthetic table of contents is synthetic because the synthetic table of contents is preferably not used for identifying or indexing any one particular physical disc.

In an alternative embodiment, the system may generate more than one synthetic table of contents. Such a situation may happen, for example, if a given chapter of the volume clearly has more than one set of acceptable durations. For instance, a recording label may record a given chapter on two different albums. Each album may intentionally have different durations for the given chapter. It is likely that the system receives the durations from the user devices, and then determines that the given chapter clearly has two sets of acceptable durations. For instance, the received durations for the given chapter may include 25 durations of about 2 minutes, and may also include 20 durations of about 3 minutes. A statistical analysis performed on the received durations may show that there are clearly two sets of acceptable durations—one set for durations that are about 2 minutes, and one set for durations that are about 3 minutes. Accordingly, the system may then generate two synthetic tables of contents because of that chapter that clearly has two legitimate representative durations. Other reasons for multiple synthetic tables of contents exist as well.

### Other Statistical Analyses for Generating a Synthetic Table of Contents

The system may use other statistical analyses for determining the representative duration for each chapter. For example, another statistical analysis may include without limitation the following: a statistical weighting of each of the durations from the user devices, the average of the durations from the user devices, the average of the acceptable durations from the user devices, the mode of the durations from the user devices, the mode of the acceptable durations from the user devices, the median of the durations from the user devices, and/or the median of the acceptable durations from the user devices.

One example of a statistical weighting involves assigning a weight of 1/X to a particular duration, where X is the number of standard deviations that the particular duration is away from the average duration for a chapter. The system may then identify the acceptable durations as the durations that are above a predetermined weight. Next, the system may apply a statistical analysis to these acceptable durations in order to determine the representative duration for the given chapter. For example, the system may calculate the average of the acceptable durations in order to determine the representative duration for the chapter. Alternatively, the system may calculate the mode of the acceptable durations in order to determine the representative duration for the chapter. Alternatively, the system may calculate the median of the acceptable durations in order to determine the representative duration for the chapter.

In another embodiment, the system may calculate the average of the durations from the user devices, and then use that average as the representative duration for the given chapter. Alternatively, the system may calculate the mode of the durations from the user devices, and then use that mode as the representative duration for the given chapter. Alternatively, the system may calculate the median of durations from the user devices, and then use that median as the representative duration for the given chapter. Other statistical analyses exist as well.

### Overview of Method for Generating a Synthetic Table of Contents

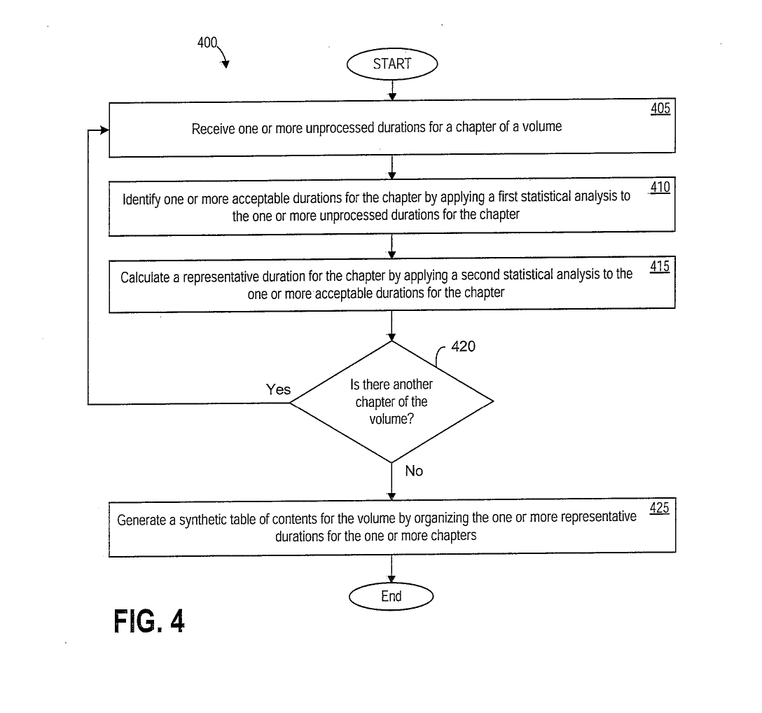

FIG. 4 is flowchart of a method 400 for generating a synthetic table of contents of a volume, in accordance with some embodiments. The steps of the method 400 are preferably carried out by one or more devices of the system 100 of FIG. 1.

The method 400 starts in a step 405 where the system receives one or more unprocessed durations for a chapter of a volume. For example, an application server may receive one or more unprocessed durations of occurrences of the chapter of the volume. The application server preferably receives the durations from one or more user devices. The method 400 then moves to a step 410 where the system identifies one or more acceptable durations for the chapter. The system identifies the acceptable durations by applying a first statistical analysis to the one or more unprocessed durations for the chapter. For example, the system may accept for further processing only the durations that are less than one standard deviation away from the maximum duration.

Next, in a step 415, the system calculates a representative duration for the chapter by applying a second statistical analysis to the one or more acceptable durations for the chapter. For example, the system may calculate the average of the acceptable durations in order to determine the representative duration. The result is a representative duration that is preferably a highly representative duration for the given chapter.

The method 400 then proceeds to a decision operation 420 where the system determines if there is another chapter of the volume. A volume typically includes multiple chapters. For example, a given album (volume) may include 15 music tracks (chapters). If the system determines that there is another chapter of the volume, then the system returns to the step 405 where the system receives one or more unprocessed durations for another chapter of the volume. However, if the system determines that there is not another chapter of the volume, then the method 400 moves to a step 425 where the system generates a synthetic table of contents for the volume. The system organizes the one or more representative durations for the one or more chapters in order to generate the synthetic table of contents. The method 400 concludes after the system generates the synthetic table of contents in the step 425.

Note that the method 400 may include other details that are not discussed in this method overview. Other details are discussed with reference to the appropriate figures and may be a part of the method 400, depending on the embodiment.

### III.

### Searching Data by Using a Synthetic Table of Contents

The system may use a synthetic table of contents to facilitate searching for information related to a volume (e.g., album). The synthetic table of contents may serve as an identifier for the volume. The synthetic table of contents provides, in a single table of contents, a representation of many tables of contents. This single table of contents is substantially less data than the sum of all the tables of contents from various user devices. As explained further below, searching for data related to the volume is substantially more efficient with use of the synthetic table of contents.

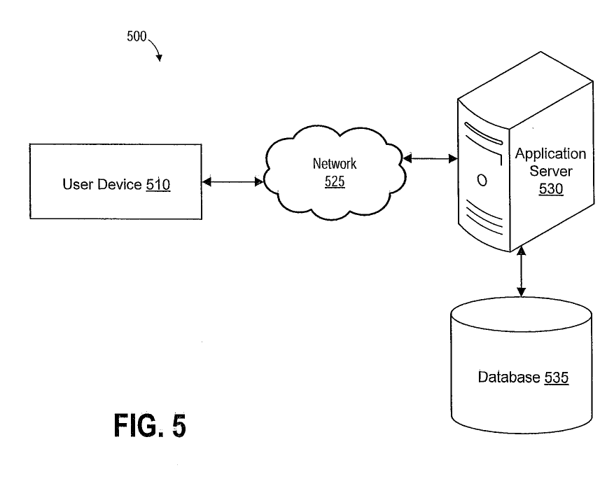

FIG. 5 is a block diagram of a system 500 for searching for volumes by using synthetic tables of contents, in accordance with some embodiments. An exemplary generation of a synthetic table of contents is discussed above with reference to FIG. 2 through FIG. 4. In FIG. 5, the application server 530 is coupled to a database 535. The application server 530 is configured to search, organize and/or analyze the database 535. The database 535 includes one or more synthetic table of contents for volumes. The application server 530 is configured to search, organize and/or analyze the synthetic tables of contents in the database 535 in an efficient manner.

A network 525 couples the application server 530 and a user device 510. The system 500 includes one user device 510 for explanatory purposes. However, the network 525 may also be coupled to one or more other user devices, as described above with reference to FIG. 1. The user device 510 may be, for example, a laptop computer, a standalone disc player, an mp3 player or a cell phone, among other things.

Some or all software and data necessary for searching and managing synthetic tables of contents may be stored on the application server 530 and/or the user device 510. For example, the user device 510 may contain a subset or a complete set of the data available in the database 535 that is coupled to the application server 530. The user device 510 may be loaded with data from a CD-ROM (not shown). The user device 510 may store data on a hard disk of the user device. Alternatively, the user device 510 may download data to the user device 510 from the database 535 via the network 525. Other configurations exist as well.

The application server 530 is configured for searching data in the database 535. For example, the application server 530 may be configured for searching synthetic tables of contents of volumes. Other examples of different types of data exist as well. U.S. Patent Application Publication No. US-2007-0288478-A1 (the '478 patent application), entitled “Method and System for Media Navigation”, is hereby incorporated by reference. The '478 patent application provides an example of a method for navigating and searching through media on a database.

In some embodiments, a synthetic table of contents may be referred to as a signature. The synthetic tables of contents (e.g., signatures) may be arranged in clusters as described in the U.S. patent application Ser. No. 12/456,194 by Jens Nicholas Wessling, entitled “Generating a Representation of a Cluster of Signatures by Using Weighted Sampling”, herein incorporated by reference. During a search, identifying (e.g., recognizing) a cluster may occur more efficiently by searching representations of clusters, instead of the synthetic tables of contents (e.g., signatures) within the clusters.

Identifying a volume may involve preliminary operations of generating a synthetic table of contents for the volume, as discussed above with reference to other figures. U.S. patent application Ser. Nos. 12/378,841 and 12/378,840 entitled “Recognizing a Disc”, which are hereby incorporated by reference, provide examples of methods for identifying (e.g., recognizing) a disc, among other items.

The user device 510 may access the database 535 via the network 525. For example, the user may insert a disc while the user device 510 is coupled to the network 525. The disc may be, for example, a Blu-ray Disc. The user device 510 may send to the application server 530 a query for data about a particular volume. The application server 530 may then provide the relevant data by accessing the database 535 according to the appropriate synthetic table of contents. The user device 510 may also retrieve the relevant data from the database 535 upon receiving a user's manual request.

Alternatively, the user device 510 may perform a more comprehensive download of data from the database 535 to the user device 510. While the user device 510 is offline, the user device 510 may then provide relevant data according to a recognized synthetic table of contents in the user device 510. For example, the user may insert a disc while the user device 510 is offline from the network 525. The disc may be, for example, a Blu-ray Disc. The user device 510 may then provide the relevant data by locating the appropriate synthetic table of contents in the user device 510. The user device 510 may also retrieve the relevant data from the user device 510 upon receiving a user's manual request.

### IV.

### Computer Readable Medium Implementation

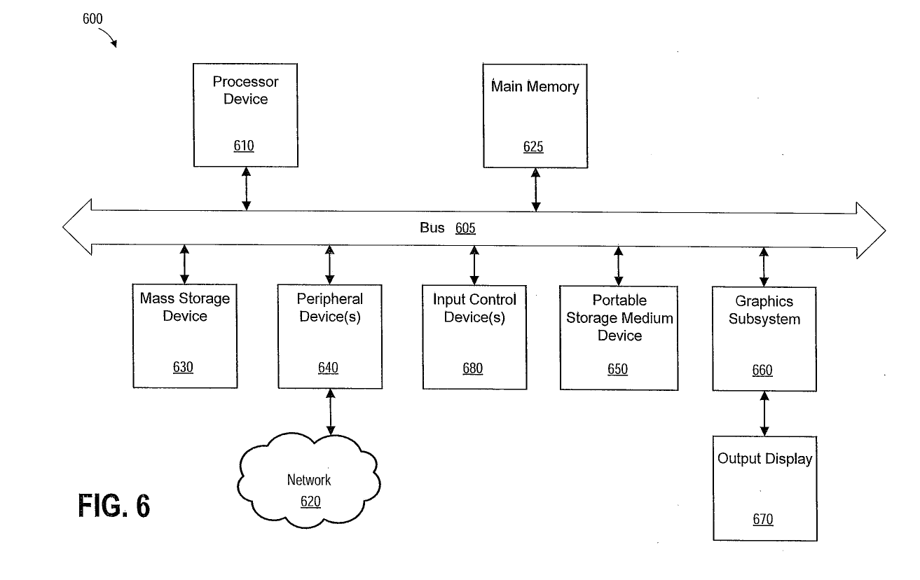

FIG. 6 is a block diagram of a general/special purpose computer system 600, in accordance with some embodiments. The computer system 600 may be, for example, a user device, a user computer, a client computer and/or a server computer, among other things. Examples of a user device include without limitation a Blu-ray Disc player, a personal media device, a portable media player, an iPod™, a Zune™ Player, a laptop computer, a palmtop computer, a smart phone, a cell phone, a mobile phone, an mp3 player, a digital audio recorder, a digital video recorder, a CD player, a DVD player, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

The computer system 600 preferably includes without limitation a processor device 610, a main memory 625, and an interconnect bus 605. The processor device 610 may include without limitation a single microprocessor, or may include a plurality of microprocessors for configuring the computer system 600 as a multi processor system. The main memory 625 stores, among other things, instructions and/or data for execution by the processor device 610. If the system for generating a synthetic table of contents is partially implemented in software, the main memory 625 stores the executable code when in operation. The main memory 625 may include banks of dynamic random access memory (DRAM), as well as cache memory.

The computer system 600 may further include a mass storage device 630, peripheral device(s) 640, portable storage medium device(s) 650, input control device(s) 680, a graphics subsystem 660, and/or an output display 670. For explanatory purposes, all components in the computer system 600 are shown in FIG. 6 as being coupled via the bus 605. However, the computer system 600 is not so limited. Devices of the computer system 600 may be coupled through one or more data transport means. For example, the processor device 610 and/or the main memory 625 may be coupled via a local microprocessor bus. The mass storage device 630, peripheral device(s) 640, portable storage medium device(s) 650, and/or graphics subsystem 660 may be coupled via one or more input/output (I/O) buses. The mass storage device 640 is preferably a nonvolatile storage device for storing data and/or instructions for use by the processor device 610. The mass storage device 630, which may be implemented, for example, with a magnetic disk drive or an optical disk drive. In a software embodiment, the mass storage device 630 is preferably configured for loading contents of the mass storage device 630 into the main memory 625.

The portable storage medium device 650 operates in conjunction with a nonvolatile portable storage medium, such as, for example, a compact disc read only memory (CD ROM), to input and output data and code to and from the computer system 600. In some embodiments, the software for generating a synthetic table of contents may be stored on a portable storage medium, and may be inputted into the computer system 600 via the portable storage medium device 650. The peripheral device(s) 640 may include any type of computer support device, such as, for example, an input/output (I/O) interface configured to add additional functionality to the computer system 600. For example, the peripheral device(s) 640 may include a network interface card for interfacing the computer system 600 with a network 620.

The input control device(s) 680 provide a portion of the user interface for a user of the computer system 600. The input control device(s) 680 may include a keypad and/or a cursor control device. The keypad may be configured for inputting alphanumeric and/or other key information. The cursor control device may include, for example, a mouse, a trackball, a stylus, and/or cursor direction keys. In order to display textual and graphical information, the computer system 600 preferably includes the graphics subsystem 660 and the output display 670. The output display 670 may include a cathode ray tube (CRT) display and/or a liquid crystal display (LCD). The graphics subsystem 660 receives textual and graphical information, and processes the information for output to the output display 670.

Each component of the computer system 600 may represent a broad category of a computer component of a general/special purpose computer. Components of the computer system 600 are not limited to the specific implementations provided here.

Portions of the invention may be conveniently implemented by using a conventional general purpose computer, a specialized digital computer and/or a microprocessor programmed according to the teachings of the present disclosure, as will be apparent to those skilled in the computer art. Appropriate software coding may readily be prepared by skilled programmers based on the teachings of the present disclosure. Some embodiments may also be implemented by the preparation of application-specific integrated circuits or by interconnecting an appropriate network of conventional component circuits.

Some embodiments include a computer program product. The computer program product may be a storage medium/media having instructions stored thereon/therein which can be used to control, or cause, a computer to perform any of the processes of the invention. The storage medium may include without limitation floppy disk, mini disk, optical disc, Blu-ray Disc, DVD, CD-ROM, micro-drive, magneto-optical disk, ROM, RAM, EPROM, EEPROM, DRAM, VRAM, flash memory, flash card, magnetic card, optical card, nanosystems, molecular memory integrated circuit, RAID, remote data storage/archive/warehousing, and/or any other type of device suitable for storing instructions and/or data.

Stored on any one of the computer readable medium/media, some implementations include software for controlling both the hardware of the general/special computer or microprocessor, and for enabling the computer or microprocessor to interact with a human user or other mechanism utilizing the results of the invention. Such software may include without limitation device drivers, operating systems, and user applications. Ultimately, such computer readable media further includes software for performing aspects of the invention, as described above.

Included in the programming/software of the general/special purpose computer or microprocessor are software modules for implementing the processes described above. The processes described above may include without limitation the following: receiving one or more unprocessed durations for each chapter of the volume, wherein the volume includes one or more chapters; identifying one or more acceptable durations for each chapter by applying a first statistical analysis to the one or more unprocessed durations for each chapter; calculating a representative duration for each chapter by applying a second statistical analysis to the one or more acceptable durations for each chapter, wherein the calculating generates one or more representative durations for the one or more chapters; and generating a synthetic table of contents for the volume by organizing the one or more representative durations for the one or more chapters of the volume.

### ADVANTAGES

The system described above is configured for generating a synthetic table of contents for a volume by using statistical analysis. The synthetic table of contents provides, in a single table of contents, an effective representation of preferably two or more tables of contents. This single table of contents is preferably substantially less data than the sum of all the tables of contents from user devices. The condensed data of the synthetic table of contents allows data associated with the volume to be searched, organized, located and/or analyzed in a substantially more efficient manner.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for generating a synthetic table of contents for a volume, wherein the method is configured to be carried out by at least one computer, the method comprising:
receiving one or more unprocessed durations for each chapter of the volume, wherein the volume includes one or more chapters;
identifying one or more acceptable durations for each chapter by applying a first statistical analysis to the one or more unprocessed durations for each chapter; and
calculating a representative duration for each chapter by applying a second statistical analysis to the one or more acceptable durations for each chapter, wherein the calculating generates one or more representative durations for the one or more chapters.

2. The method of claim 1, further comprising generating a synthetic table of contents for the volume by organizing the one or more representative durations for the one or more chapters of the volume.

3. The method of claim 1, wherein each unprocessed duration is a duration of an occurrence of a chapter, wherein an occurrence is a copy of the chapter, wherein the one or more unprocessed durations are received from one or more user devices configured for storing occurrences, and wherein each user device is a client part of a client-server architecture.

4. The method of claim 1, wherein the first statistical analysis comprises at least one of:
calculating a standard deviation of the one or more unprocessed durations;
discarding one or more unprocessed durations that are more than one standard deviation away from a highest unprocessed duration; and
accepting one or more unprocessed durations that are less than one standard deviation away from the highest unprocessed duration.

5. The method of claim 1, wherein the first statistical analysis comprises at least one of:
calculating a standard deviation of the unprocessed durations for each chapter;
calculating an average unprocessed duration of the unprocessed durations for each chapter;
calculating a number of standard deviations that each unprocessed duration is away from each average unprocessed duration;
assigning a weight to each unprocessed duration, wherein each weight comprises 1 divided by the number of standard deviations that each unprocessed duration is away from the average unprocessed duration for each chapter;
discarding one or more unprocessed durations that are less than a predetermined weight; and
accepting one or more unprocessed durations that are greater than a predetermined weight.

6. The method of claim 1, wherein the second statistical analysis comprises at least one of:
calculating an average acceptable duration of the acceptable durations for each chapter, wherein each representative duration is an average acceptable duration for a particular chapter;
calculating a mode acceptable duration of the acceptable durations for each chapter, wherein each representative duration is a mode acceptable duration for a particular chapter; and
calculating a median acceptable duration of the acceptable durations for each chapter, wherein each representative duration is a median acceptable duration for a particular chapter.

7. The method of claim 1, wherein the second statistical analysis comprises at least one of:
calculating an average unprocessed duration of the unprocessed durations for each chapter, wherein each representative duration is an average unprocessed duration for a particular chapter;
calculating a mode unprocessed duration of the unprocessed durations for each chapter, wherein each representative duration is a mode unprocessed duration for a particular chapter; and
calculating a median unprocessed duration of the unprocessed durations for each chapter, wherein each representative duration is a median unprocessed duration for a particular chapter.

8. The method of claim 1, wherein each representative duration is a highly representative duration of at least one of:
a given chapter; and
one or more acceptable durations for the given chapter.

9. The method of claim 2, wherein the synthetic table of contents is an effective representation of two or more tables of contents of the volume, wherein the synthetic table of contents is less data than the two or more tables of contents of the volume, and wherein the synthetic table of contents is not configured to be used for identifying any one particular physical disc.

10. The method of claim 2, wherein the synthetic table of contents allows data associated with the volume to be at least one of:
searched in an efficient manner;
organized in an efficient manner;
located in an efficient manner; and
analyzed in an efficient manner;

11. The method of claim 2, wherein the synthetic table of contents is an identifier for the volume, wherein the identifier is a signature that uniquely identifies the volume.

12. The method of claim 1, wherein the volume is at least one of:
an album;
a movie;
a book;
a magazine;
a publication;
a compact disc;
a digital video disc; and
a Blu-ray Disc.

13. The method of claim 1, wherein each chapter is at least one of:
an audio track;
a video track;
a song;
a book chapter;
a magazine chapter;
a publication chapter;
a compact disc chapter;
a digital video disc chapter; and
a Blu-ray Disc chapter.

14. A system for generating a synthetic table of contents for a volume, wherein the system is configured for:
receiving one or more unprocessed durations for each chapter of the volume, wherein the volume includes one or more chapters;
identifying one or more acceptable durations for each chapter by applying a first statistical analysis to the one or more unprocessed durations for each chapter; and
calculating a representative duration for each chapter by applying a second statistical analysis to the one or more acceptable durations for each chapter, wherein the calculating results in one or more representative durations for the one or more chapters.

15. The system of claim 14, wherein the system is further configured for generating a synthetic table of contents for the volume by organizing the one or more representative durations for the one or more chapters of the volume.

16. The system of claim 14, wherein each unprocessed duration is a time duration of an occurrence of a chapter, wherein an occurrence is a copy of the chapter, wherein the one or more unprocessed durations are received from one or more user devices configured for storing occurrences, and wherein each user device is a client part of a client-server architecture.

17. The system of claim 14, wherein the first statistical analysis comprises at least one of:
calculating a standard deviation of the one or more unprocessed durations;
discarding one or more unprocessed durations that are more than one standard deviation away from a highest unprocessed duration; and
accepting one or more unprocessed durations that are less than one standard deviation away from the highest unprocessed duration.

18. The system of claim 14, wherein the first statistical analysis comprises at least one of:
calculating a standard deviation of the unprocessed durations for each chapter;
calculating an average unprocessed duration of the unprocessed durations for each chapter;
calculating a number of standard deviations that each unprocessed duration is away from each average unprocessed duration;
assigning a weight to each unprocessed duration, wherein each weight comprises 1 divided by the number of standard deviations that each unprocessed duration is away from the average unprocessed duration for each chapter;
discarding one or more unprocessed durations that are less than a predetermined weight; and
accepting one or more unprocessed durations that are greater than a predetermined weight.

19. The system of claim 14, wherein the second statistical analysis comprises at least one of:
calculating an average acceptable duration of the acceptable durations for each chapter, wherein each representative duration is an average acceptable duration for a particular chapter;
calculating a mode acceptable duration of the acceptable durations for each chapter, wherein each representative duration is a mode acceptable duration for a particular chapter; and
calculating a median acceptable duration of the acceptable durations for each chapter, wherein each representative duration is a median acceptable duration for a particular chapter.

20. The system of claim 14, wherein the second statistical analysis comprises at least one of:
calculating an average unprocessed duration of the unprocessed durations for each chapter, wherein each representative duration is an average unprocessed duration for a particular chapter;
calculating a mode unprocessed duration of the unprocessed durations for each chapter, wherein each representative duration is a mode unprocessed duration for a particular chapter; and
calculating a median unprocessed duration of the unprocessed durations for each chapter, wherein each representative duration is a median unprocessed duration for a particular chapter.

21. The system of claim 14, wherein each representative duration is a highly representative duration of at least one of:
a given chapter; and
one or more acceptable durations for the given chapter.

22. The system of claim 15, wherein the synthetic table of contents is an effective representation of two or more tables of contents of the volume, wherein the synthetic table of contents is less data than the two or more tables of contents of the volume, and wherein the synthetic table of contents is not configured to be used for identifying any one particular physical disc.

23. The system of claim 15, wherein the synthetic table of contents allows data associated with the volume to be at least one of:
searched in an efficient manner;
organized in an efficient manner;
located in an efficient manner; and
analyzed in an efficient manner;

24. The system of claim 15, wherein the synthetic table of contents is an identifier for the volume, wherein the identifier is a signature that uniquely identifies the volume.

25. The system of claim 14, wherein the volume is at least one of:
an album;
a movie;
a book;
a magazine;
a publication;
a compact disc;
a digital video disc; and
a Blu-ray Disc.

26. The system of claim 14, wherein each chapter is at least one of:
an audio track;
a video track;
a song;
a book chapter;
a magazine chapter;
a publication chapter;
a compact disc chapter;
a digital video disc chapter; and
a Blu-ray Disc chapter.

27. A computer readable medium comprises one or more instructions for generating a synthetic table of contents for a volume, wherein the one or more instructions are configured to cause one or more processors to perform the steps of:
receiving one or more unprocessed durations for each chapter of the volume, wherein the volume includes one or more chapters;
identifying one or more acceptable durations for each chapter by applying a first statistical analysis to the one or more unprocessed durations for each chapter; and
calculating a representative duration for each chapter by applying a second statistical analysis to the one or more acceptable durations for each chapter, wherein the calculating results in one or more representative durations for the one or more chapters.
